(19) United States
(12) Patent Application Publication
(10) Pub. No.: US 2009/0106169 A1
(43) Pub. Date: Apr. 23, 2009

(54) METHOD FOR ENABLING AMERICAN INDIAN TRIBES TO ATTRACT EQUITY CAPITAL INVESTMENT

(76) Inventor: Joseph W. Carlson, Pleasant Grove, UT (US)

Correspondence Address: ANGUS C. FOX, III, 4093 N. IMPERIAL WAY, PROVO, UT, 84604-5386, US

(21) Appl. No.: 12/104,158

(22) Filed: Apr. 16, 2008

Related U.S. Application Data
(60) Provisional application No. 60/912,425, filed on Apr. 17, 2007.

(51) Int. Cl. G06Q 40/00

(52) U.S. Cl. 705/36 T; 705/35; 705/37

(57) ABSTRACT

A business method for deferring federal corporate income tax, whereby a pass-through entity, such as an LLC, is linked to an FT Corporation, which functions as a portable subset of a tribal reservation. Such a structure enables investors to participate as direct equity shareholders in the pass-through entity, thereby ensuring their right to vote as a minor or majority equity interest holders. The structure also enables those investors to participate as virtual equity shareholders in the FT Corporation, so that they can enjoy the tax-exempt status and other financial benefits that have been conferred upon FT Corporations by the Federal Government as a means to help Indian Tribes achieve economic self-determination, without those business entities being disqualified for such special treatment.

### PRIORITY DATA

This application has a claim of priority based on the filing of provisional patent application No. 60/912,425 of the same title and by the same inventors on 2007-04-17.

### BACKGROUND OF THE INVENTION

1. Field of the Invention

The invention relates, generally, to income tax deferral methods and, more specifically, to a business structure which enables individual investors to defer income taxes through the use of a pass-through entity linked to a Federal Tribal Corporation, simultaneously enabling American Indian Tribes to attract equity capital investment.

2. History of the Prior Art

Attraction and formation of capital is the most critical factor for an ongoing success of a capitalist economic system. Governments that sponsor and rely upon such capitalistic systems also exert taxation policy on participants in said economic system to exact and transfer tax revenue collections from said participants to accumulate capital for the public good and to use a portion of such revenue in the public treasury to regulate and perpetuate the capitalist system. This is a cost to the economic system. Next to common business risk and accompanied enterprise costs, government taxation is the largest single component of impedance to capital (earnings) retention. US Corporations classified under the “C” designation are subject to the greatest tax liabilities—their earnings are taxed twice. First, a corporate income tax is imposed on its net earnings and then, after the earnings are distributed to shareholders as dividends, each shareholder must second pay taxes separately on his or her share of the dividends (Code Sections 11 and 301c). There is some current relief for individual corporate shareholders. A corporation can reduce, or even eliminate, its federal income tax liability by distributing its income as salary to shareholder-employees who actually perform valuable services to the corporations. Although this can reduce taxation on the corporate entity level, those who receive payments from a corporation in exchange for services must nevertheless pay taxes (sometimes higher) on the amount received, which is treated as salary (Code Sec. 162(a)(1)). Since 2003, qualified dividend income paid by a corporation and received by an individual is taxed as a part of net capital gain using Code Sec. 1(h)(11) as further defined in the Jobs and Growth Tax Relief Reconciliation Act of 2003 (also referred to hereafter as the “Tax Act”). Beginning in 2003 (with a sunset of the law in taxable years after the beginning of 2008, unless changed by Congress) certain “qualified dividend income” received by non-corporate taxpayers is taxed at the same rate as long-term capital gains. This treatment applies for purposes of both the regular tax and the alternative minimum tax. Thus, qualified dividend income will be taxed at rates of 5 and 15 percent. The actual mechanics of computing tax on qualified dividend income is to add such income to the amount of net capital gain that is eligible for the 15 percent or 5 percent tax rate on capital gains. These changes made holding of preferred stock more attractive relative to debt, since dividends received are currently subject to a much lower income tax rate than interest on debt. The Tax Act also helped individuals find that holding of preferred stock was more attractive than in the past, since such preferred stock can provide a more secure return than common stock, and since their tax rate on dividends (at 15 percent) will now compare much more favorably to the tax rate applicable to corporate shareholders eligible for the 70 percent dividends received deduction (10.5 percent).

In summary, the tax policy built into the Tax Act provided an incentive for distributing earnings currently, rather than accumulating them, since dividends are currently taxed at the same rate as if the shareholder sold the stock and realized capital gains. After 2008, everything reverts to the past-dividends will be taxed at higher rates and investors will seek investment preferences that will swing back to equities (stock investments) for their appreciating value potential and usual capital gains treatments. If the Tax Act is not extended, the value of the present invention increases as its business process structure becomes the only economically tax-enhanced equity investment vehicle available to investors. Notwithstanding the pending changes in the Tax Act, the present invention is still superior to any other alternative business process investment structure.

The current US corporate taxation scheme differs radically from the tax rules applied to S Corporation, partnerships, limited liability companies and sole proprietorships. These structures do not pay an entity-level income tax on their earnings like C Corporations. There is no partnership income tax (Code Sec. 701). Nor (in most cases) is there an S Corporation income tax, limited liability company income tax, or sole proprietorship income tax (Code Sec. 1363). Only the owners or members of these legal entities are taxed on their share of entity's earnings that are “passed through” to the taxpayer and then taxed at existing marginal tax rates.

Likewise, an Employ Stock Option Plan (ESOP) is a highly regulated and qualified structure (association under trust) that Companies can use for a variety of purposes. The most common usage of an ESOP is to provide a liquid market for the shares of departing owners of successful closely held companies and to motivate and reward employees. Their most sensational attention has focused on ESOPs in public companies used as a takeover defense or exchanges of stock to obtain concessions for common business purposes. Finally, ESOPs are unique among employee benefit plans in their ability to borrow money for acquiring new assets using pretax dollars. In a Leveraged Buy-Out (LBO), the ESOP borrows cash, which it uses to buy out company shares or shares of existing owners. The acquired company then makes tax-deductible contributions to the ESOP to repay the loan, meaning both principal and interest are tax deductible. Some unrelated prior art is being done to attach pass-through entitles to such qualified ESOP structures. This approach differs from the present invention which joins sovereign Tribal corporate entities with active pass-through entities engaged in equity-based acquisitions partially or fully backed by outside investors.

In addition, separate from ESOPs, Roth IRAs have some unique taxation features regarding the postponement of tax payments on IRA earned income but are strictly limited in quantities of capital contributed and capital withdrawn and their respective timings of contributions or withdrawals. The present invention utilizes business processes that have no statutory limits on the timing, types and kinds of enterprises or investments that can be made examples of which are illustrated in the preferred embodiment.

The only legal entity-level structure that can uniquely retain earnings and yet not pay an entity-level tax on such earnings is a sovereign FT Corporation (Revenue Ruling 94-16). Dividends paid by an FT Corporation are also not classified as “Dividends from Tax Exempt Corporations” according to the Tax Act. Dividends paid by those corporations exempt from tax under IRC Section 501 (general tax exempt organizations) or 521 (tax-exempt farmers' cooperatives) are not eligible for the lower tax rate of 15 percent tax rate on their dividends under the Jobs and Growth Tax Relief Reconciliation Act of 2003. The present invention uniquely conjoins FT Corporations and pass-through entities utilizing new art.

Although FT Corporations have extraordinary powers, there are trade-offs that limit their ultimate reach and utility for Tribes in commercial society. Originally, Fairplains, LLC, the innovators of federal tribal securities such as Preferred Non-voting Shares issue by FT Corporations, asserted to government regulators (at DOI and IRS) that said preferred shares issued by an FT Corporation, although having no voting rights, were nonetheless original “equity” with full equity rights (including asset appreciation rights and rights providing claims on assets even under conditions of bankruptcy). After subsequent conversations and debate with the Interior Department between September 2006 and March 2007, assets held in an FT Corporation, itself being sovereign, were construed as “trust-like” assets that accordingly and traditionally under US American Indian law required that no non-Indian interest be attached or vested in the FT Corporation assets by means of equity ownership. This development created a drafting and structuring challenge for investors relative to direct or actual equity ownership of their at-risk investments in an FT Corporation. As such, to capitalize or re-capitalize an FT Corporate enterprise, if the Preferred Non-voting Shares (investment instruments purchased in the investment exchange or transaction) are not structured correctly, a tax court of competent jurisdiction could test and rule that said preferred investment instruments were debt rather than equity—wiping out all beneficial representations and equity claims of the instrument(s) as to e.g. available investment tax credits (for assets established in qualified development zones, etc.) and/or capital gains treatments of the appreciated value of the corporate asset established by the investment and/or qualified dividends received from the underlying investment instruments (such dividends are currently and attractively taxed at the lower dividend rate under the Jobs and Growth Tax Relief Reconciliation Act of 2003). Such a resulting adverse tax ruling would certainly relegate investors to be bankers/lenders rather than equity owners/members also conjointly foreclosing the opportunity of an FT Corporation to raise equity capital or trade in corporate equity. With additional repercussions, interest received or accrued on the investments that were reclassified as debt shall be taxed at higher ordinary income tax rates (Reg. §1.61-7; including at Code Sec. 543.) and may also include penalties for unpaid taxes to be paid on recaptured interest income. Other equity issues also remained that the present invention resolved.

Most institutional investors are constrained in their funds' bylaws to only make investments where the investment managers of said funds have fiduciary duties to retain voting control over their investments. In other words, certain preferred shares (not traded on public exchanges) are not a viable investment option for certain private equity and venture firms who are charged with safely placing their investments out of their private equity funds and into selected equity investment instruments. When there is no public market to provide investment liquidity for such investments, private control of the investment is paramount so as to meet the criteria of investment company bylaws. As such, a Preferred Non-voting Share issued by a FT Corporation may be mostly unattractive for pure equity investment purposes due to lack of voting rights. The present invention ameliorates these voting control constraints in securities of FT Corporations by shifting the voting control to an affiliated pass-through entity where the operating assets and voting equity can reside.

A state-registered limited liability company (LLC) can be taxed as a partnership for federal income tax purposes. However, its members, like corporate shareholders, are not personally liable for the entity's debts and liabilities. Under the “check the box” rules, the IRS allows an LLC to elect to partnership status to avoid taxation at the entity level (as an “association taxed as a corporation”).

Voting LLC members may participate in management without risking personal liability. No limitations are placed on the number or types of equity owners of LLCs. (There is a maximum number of owners for both “S” Corporations and “C” Corporations especially with regard to public financial disclosure when a certain number is reached). Furthermore, “S” Corporations, taxed as partnerships, can not discriminate between stockholders (persons only) with regard to distributions. LLCs can. Unlike any other structure for conducing legal activities, an LLC has the ability (under Code Sec. 704) to make disproportionate (all or partial) membership allocations and distributions that include such tax-deductible items as investment credits, depreciation and depletions through-out its organizational tenure and to distribute appreciated property to members without entity-level recognition of taxable gain (Code Sec. 731(b). LLC members may also exchange appreciated property for membership interests without recognition of gain or loss (Code Sec. 721). Subject to its Operating Agreement, the LLC is a true pass-through entity with voting equity rights and investment basis taxation rights.

### SUMMARY OF THE INVENTION

The present invention provides a novel business method whereby a pass-through entity, such as an LLC, is linked to an FT Corporation, which functions as a portable subset of a tribal reservation. Such a structure enables investors to participate as direct equity shareholders in the pass-through entity, thereby ensuring their right to vote as a minor or majority equity interest holders. The structure also enables those investors to participate as virtual equity shareholders in the FT Corporation, so that they can enjoy the tax-exempt status and other financial benefits that have been conferred upon FT Corporations by the Federal Government as a means to help Indian Tribes achieve economic self-determination, without those business entities being disqualified for such special treatment. Given that there is no prior history or prior art regarding the joining of an FT Corporation to a pass-through entity such as a limited liability company (LLC), the present invention should be considered novel. In addition, given the immense potential value and utility of the present invention to those trained in the arts of taxation and finance, the invention should also be considered non-obvious.

The present invention is described in more detail in a book authored by the inventor Joseph W. Carlson, titled Handbook of Equity Capital Formation for Economic Development of American Indian Tribes, First edition, published by Windwright LLC, Salt Lake City, Utah, © 2008. This book, which is being submitted with this patent application, is incorporated herein in its entirety.

### BRIEF DESCRIPTION OF THE DRAWINGS

FIG. 1 is a diagram depicting a preferred structure for enabling investors, who are non-tribal members, to enjoy the tax-exempt status and other financial benefits granted to FT Corporations, by participating as direct equity shareholders with voting rights in a pass-through entity that is linked to an FT Corporation.

### DETAILED DISCLOSURE OF THE INVENTION

The business method and business organizational structure which constitute the invention will now be described with reference to the attached drawing FIGURE.

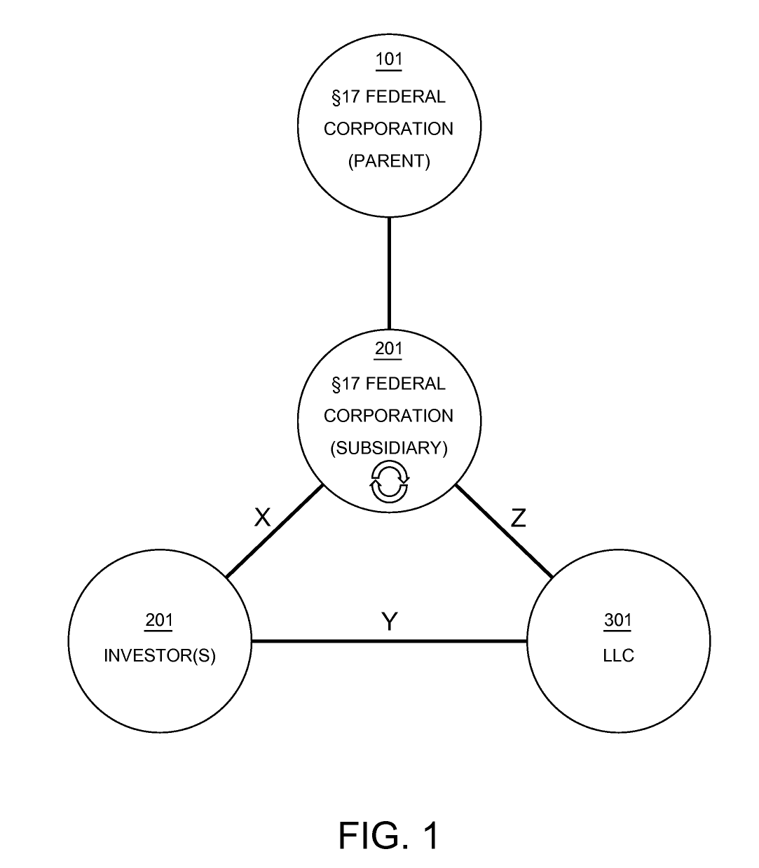

Referring now to FIG. 1, the invention utilizes three business entities to generate the economic outcomes that optimize all the investment and taxation benefits to Tribes and investors described herein. It will be also shown that the present business process invention also has useful and practical application to Mergers and Acquisitions. The first business entity is a Parent §17 FT Corporation 101 formed by Tribal resolution authorized and issued under 25 U.S.C. §477. The second business entity is a Subsidiary §17 FT Corporation 102, which is also formed by the same regulatory method, wholly controlled by the Parent §17 FT Corporation 101. The purpose of the Subsidiary §17 FT Corporation 102 is to isolate specific and separate enterprise risk from the Parent §17 FT Corporation 101. The Subsidiary §17 Corporation 102 can also be a general partner in a limited partnership whose partnership interests may privately or publicly traded. Using the present invention, 102 may also be a wholly-owned subsidiary Single-member Limited Liability Company (LLC). The third business entity is a Multiple-Member Limited Liability Company (LLC) 103 that is formed and owned—at least in part—by the Subsidiary §17 FT Corporation 102. Both the Parent §17 FT Corporation 101 and the Subsidiary §17 FT Corporation 102 are exempt from federal income taxes earned on or off the Tribe's reservation. In addition, if the LLC 103 is a Single-Member entity as a subdivision of its Subsidiary §17 FT Corporation owner, it is also considered a “disregarded entity” for Federal income tax purposes. Investment in the LLC 103 is provided by at least one Investor 104 with the Subsidiary §17 FT Corporation 102 receiving potentially disproportionate retained earnings through the LLC 103. By means of the business structure depicted in FIG. 1, Investors 104 are able to maintain uninterrupted control and return of their investments by means of voting rights through an operating agreement provided by the LLC 103. It will be noted that the LLC 103 is connected to both the Investors 104 and to the Subsidiary §17 FT Corporation.

The function of the business structure depicted in FIG. 1 will now be described in the context of three Tribal Acquisition processes. The first acquisition process can be in the form of either an outright purchase of an asset in exchange for cash, or a cash purchase of the stock of a target company. In either case, the sales price is the new tax basis for the acquired asset(s) or stock. Following a negotiation of the price and terms of the transaction in the context of the business structure outlined herein, the Seller enters into a definitive agreement to sell the asset or business to the Tribe. In the context of the transaction, the Seller must calculate any loss or gain on the sale. Losses can generally be carried over and applied to future tax periods. Any gain will result in taxes being paid to the IRS from the proceeds of the transaction. A detailed discussion of the tax consequences of asset or stock sales by Sellers is outside the scope of this disclosure. Rather, the focus of this disclosure will be on the tax consequences of having the LLC 103 purchase businesses or assets using equity capital provided by the Tribe and Investors. In addition, although there are many proportional variations of beneficial interests that may be owned by Subsidiary §17 Corporation 102 and Investor(s) 104 in the LLC 103 by virtue of the flexibility of an LLC to make disproportionate membership allocations and distributions, this illustration is just one embodiment which does not limit the general usage of the present invention for the purpose described herein. Therefore, Investor(s) 104 and the Parent §17 Corporation 101 enter into negotiations to acquire a target company or a particular target asset from the Seller, which target company or target asset will become or be absorbed into the business of the LLC 103. The primary purpose of this business structure is, of course, to establish federal corporate subsidiary entities (both Subsidiary §17 Corporation 102 and LLC 103 are such entities) that are not subject to federal income tax on income earned in the conduct of a commercial business on or off the Tribe's reservation. Such a structure is ideally suited for (a) holding, retaining, and recompounding pass-through earnings from LLC 103, and (b) for paying qualified dividends at lower tax rates on its issued preferred shares. Feature (b) enables the creation of a sinking fund(s) of tax-exempt compounding retained earnings, which eventually provide exit financing for Investor 104 or other financing purposes. Feature (b) enables Investor(s) 104 to effectively service their investment returns at low-tax-cost if intermediate cash flows (dividends) over the term are required to meet the cash flow investment criteria of Investor(s) 104.

The second acquisition process proceeds by Investor(s) 104 tendering loans to the Subsidiary §17 Corporation 102 and investment cash and other good and valuable consideration simultaneously to the LLC 103 in exchange for both (1) promissory notes issued by the Subsidiary §17 Corporation 102 to investor(s) 104 and (2) Membership Interests in and for capitalization of the LLC 103. From the proceeds of loans to the Subsidiary §17 Corporation 102, the Subsidiary §17 Corporation 102 capitalizes or purchases using cash and other good and valuable consideration the pre-negotiated and remaining Membership Interests in the LLC 103 in order to complete the LLC capitalization purposes. The loans by the Investor(s) 104 in exchange for promissory notes can be secured using the pledge of the Membership Interests purchased in the LLC 103 by the Subsidiary §17 Corporation 102. As a result of these processes and transactions, the LLC 103 is fully capitalized and owned by both the Investor(s) 104 and the Subsidiary §17 Corporation 102 on some proportional basis, with Investor(s) 104 holding a majority voting equity position-his desired and/or required fund bylaw position. For an individual Investor 104, the sum of his investments in the LLC 103 is his tax basis. The Subsidiary §17 Corporation 102 is unconcerned with the tax basis of its investment in the LLC 103, as the Subsidiary §17 Corporation 102 is exempt from federal taxes as a FT Corporation. Once the LLC 103 is fully capitalized, it can tender cash that it has raised from the sale of its membership interests to the Seller of the target asset, which can be in the form of actual assets or shares. If a company is the target asset, its net assets conveyed or outstanding stocks are conveyed to and absorbed by the LLC 103, with the stock of the purchased company being retired. The LLC 103 then becomes the operator of the purchased business.

For the third acquisition process, the holding, retaining, and re-compounding of pass-through investment earnings from LLC 103, as well as the repayment of appreciated equity capital are critical factors that Investor(s) 104 consider in the pricing of equity interests and the calculation of a projected internal rate of return (IRR) with respect to businesses operated by an LLC 103 under a tax-exempt tribal umbrella. Subject to the Operating Agreement of the Multiple-Member LLC 103, there are additional important business process variables, which can be adjusted for the design of investment instrument yields and pricing outcomes. One such set of variables are the beneficial ownership percentages that the Subsidiary §17 Corporation 102 and the Investor(s) 104 hold in the LLC 103. Another is the agreed upon membership allocations and distributions, which can be disproportionate so as to create tailored cash flows that achieve the desired IRR of the Investor(s) 104. For example, an Investor may own 60% of the equity of the LLC 103, yet directly receive only 10% of the distributions generated by the LLC 103. The remaining 90% of earning of the LLC 103 earnings is distributed to the Subsidiary §17 Corporation, which, in turn, can pay interest if a note is in place and retain the earnings in a tax-exempt investment compounding environment ultimately adequate to achieve the cash flow and reversion requirements of the Investor(s) 104. In addition, a buy-sell agreement (with “put” and “call” option provisions) will have been established between the Subsidiary §17 Corporation 102 and the Investor(s) 104 and/or between the LLC 103 and Investor(s) 104 wherewith to prepare for and ensure the eventual buy-out (reversion of appreciated equity investment) of Investor interests in the LLC 103 by Subsidiary §17 Corporation 102 using a first sinking fund built up by the earnings received over time from the LLC 103 and managed by Subsidiary §17 Corporation 102. Using this embodiment, cash proceeds from the sinking fund could be used to either recapitalize the LLC 103, which then as an entity acquires all the membership interests in the LLC 103 from the Investor(s) 104, leaving the Subsidiary §17 Corporation 102 as the sole member, or purchase the LLC membership interests directly from the Investor(s) 104, using proceeds from the sinking fund, thereby leaving the Subsidiary §17 Corporation 102 as the sole member of the LLC 103. In addition to being managers of the LLC 103, Investor(s) 104 may also be executive corporate managers of Subsidiary §17 Corporation 102. With disproportionate earnings being passed to Subsidiary §17 Corporation 102 from the LLC 103, a second sinking fund can be established to provide financing for capital asset expenditures by the LLC 103 using leveraged-lease-backs with investment tax credits and depreciation being allocated to the Investor(s) 104. Any designated residual distribution income retained in the Subsidiary §17 Corporation 102 and not used to service the needs of the Investor(s) 104 is then paid as voting common share dividends to the Parent §17 Corporation 101.

The third acquisition process disclosed above has the same application and effect in a merger. The difference in a statutory merger illustration using the preferred embodiment of the business method is that the target company that becomes the business conducted in the LLC 103 is first reorganized, or merged, into the LLC 103 subject to statutory LLC merger procedures, negotiations continuity-of-interest requirement that set both the equity type and resulting member equity allocation and the earnings distributions of the LLC 103. As such—and still relying upon the present invention—merger negotiations typically focus more on future values and synergies and relative resulting strengths of the merged entities rather than pricing. In this milieu, there is more ensuing discussion and usage of the present invention over beneficial interest percentages in future cash flows (terms) than respective enterprise pricing. For example, a merger of peers (Tribal value vis-à-vis target company value) would be close to parity—a 50/50 deal. A totally passive Subsidiary §17 Corporation 102 owner of a subsidiary LLC in a merger of a target LLC would not likely settle for a minority equity membership interest in the resulting LLC 103 for less than a 20% stake. If American Indian 8A Government Contracting preferences are in play in the merger along with BIA Federal loan guarantees being made available for present and future financings, the Subsidiary §17 Corporation 102 owned LLC may take a 60%+position in the merger with the collaterally-benefited minor merger partner taking the remaining 40% portion. If after the merger an immediate “earn-out” of the original owners of “the Business” is commenced, then disproportionate considerations between membership allocation and earnings distributions of the LLC 103 members are typically in play. All of the aforementioned terms are used as variables in the present invention to determine price. After the Merger, the Business of the LLC 103 will become seasoned with the passing of time. Again using the present invention at some future point, the Parent §17 Corporation 101 could create another Subsidiary §17 Corporation to purchase away the LLC 103 from Investor(s) 104, thereby creating a liquid event (not unlike that described in the Acquisition section) for a new set of investors to take the Business to the next level.

Here now is a proof of practical application of the present invention. An ordinary person trained in the art would use the present invention by arranging certain mathematical components used in finance to minimize the purchase price of the investment or maximize the IRR of their investments utilizing the present invention. In addition to price, the desired IRR would be ascertained given the shape and timing of cash flows that arise between the entities as described in the discussion of the structure of FIG. 1. Given the depicted cash flow connections (in flows and outflows) between Subsidiary §17 Corporation 102 and LLC 103 and Investor(s) 104 in the diagram, there are three bi-directional cash flow paths designated as X, Y and Z, where:
X=path of all outflows and inflows of cash including principal reversions and redemptions made and received between the Investor(s) 104 and Subsidiary §17 Corporation 102;
Y=path of all outflows and inflows of cash including principal reversions and redemptions made and received between the Investor(s) 104 and the LLC 103; and
Z=path of all outflows and inflows of cash including principal reversions and redemptions made and received between the Subsidiary §17 Corporation 102 and the LLC 103.
   From the perspective of Investor(s) 104, the IRR would be iteratively computed to approximate zero by taking the present value(s) of the X path and/or Y path cash inflows over the term of the investment netted against the present value of the combined initial outflows (price payment) made by the Investor(s) 104 using the X path to Subsidiary §17 Corporation 102 and/or using the Y path to the LLC 103.

The mathematical notation for the business process of the present invention encompasses a scope of variables, which include:
t=the applicable total income tax rate charged on entity level earnings (typically the federal corporate income tax rate plus the state corporate income tax rate). (1−t) equals the after-tax coefficient when multiplied to a taxable inflow amount yields the after-tax net cash inflow. In the present invention, t=0. The after-tax coefficient is included in the present mathematical notation of the business process to clearly illustrate the tax-exempt enhancements of the present invention;
P_{xy}=the Present Value (price) of the Investment(s) made through path X to the Subsidiary (2) and/or through the path Y to the LLC 103;
kₑ=the Internal Rate of Return for the equity Investment;
n=the number of years (periods) comprising the term of the investment;
A=(1−(1+kₑ)⁻ⁿ)/kₑ, which is the present value discount factor of a future level income stream of one. If level cash flows are not anticipated over the term, coefficient B would be multiplied with the each nth period intermediate cash flow;
B=(1+kₑ)⁻ⁿ, which is the present value discount factor of a future single reversion of one;
Cₓ=the annual cash returns (treated as level) accruing to the total invested capital flowing over the X path;
C_{y}=the annual cash returns (treated as level) accruing to the total invested capital flowing over the Y path;
Rₓ=the nth period reversion to total invested capital flowing back over the X path; and
R_{y}=the nth period reversion to total invested capital flowing back over the Y path.
   To determine kₑ, the IRR, P_{xy}, is set at an estimated price while variables Cₓ, C_{y}, Rₓ, and R_{y} are collectively estimated and set. By changing and replacing kₑ iteratively, the solution for the following Final Equation is satisfied by convergence to some level of acceptable precision.

P_{xy}=CₓA(1−t)+RₓB(1−t)+C_{y}A+R_{y}B

When the expression is converged to acceptable equality, if the yield of the resulting IRR of the investment is greater than the required rate of return that the Investor(s) 104 requires for his portfolio, the investment transaction is made using the present invention in the preferred embodiment at the determined investment price.

The Final Equation is also useful for determining the maximum price (present value) of the investment if kₑ is fixed by the policy of the Investor(s) 104. To determine P_{xy}, variables Cₓ, C_{y}, Rₓ, and R_{y} are collectively estimated and set along with kₑ, in the equation. By iteratively changing and replacing P_{xy}, the equation converges within an acceptable level of precision to a “price” (the purchase amount for the investment) that is offered to the seller. The right-hand side of the equation becomes the “terms” of the investment. The inventor has named the Final Equation as the “Section 17 Equity Investment Pricing Model.”

This business structure and new business processes together with the algorithms expressed above, which comprehend the combination of corporate entity-level and pass-through entity level structures that are both tax-exempt, produce a concrete, useful and tangible result. Indeed, a “price” (and yield) for a tax-exempt enhanced financial product (e.g. the investment instruments described herein) is considered to be a concrete, useful and tangible result of the new art of the business process of the present invention herein disclosed. (See State Street Bank decision).

An ordinary person trained in the art can employ a computer program that uses a declarative language (such as a spreadsheet program) to program the final equation and resulting price using all the variables as parameters of the investment. Because Subsidiary §17 Corporation 102 and the LLC 103 do not pay taxes at the entity-level, Investor(s) 104 are benefited by the promise of greater compounding returns on capital invested (IRR) due to non-taxation of retained earnings held recompounding in the Subsidiary §17 Corporation 102 and for favorable treatments on interim dividends received. The Parent §17 Corporation 101 is also greatly benefited by the structure of the present invention by the ultimate earnings consolidations made and paid to it.

Although only a single embodiment of the present invention has been disclosed herein, it will be obvious to those having ordinary skill in the art that changes and modifications may be made thereto without departing from the scope and spirit of the invention as hereinafter may be claimed.

What is claimed is:

1. A business structure for deferring federal taxation of corporate profits, said method comprising:
a §17 Federal Tribal (FT) Corporation having federal tax exempt status; and
at least one pass-through entity linked to the FT Corporation, said pass-through entity having
equity voting rights and investment basis taxation rights;
wherein said pass-through entity is authorized to sell equity interests therein which are representative of equity capital investments received from non-tribal members; and
whereby said business structure provides an opportunity for said non-tribal investors to receive an enhanced return on investment as a consequence of the tax-exempt status of the FT Corporation, and a degree of control over their equity capital investments.

2. The business structure of claim 1, wherein linking of said at least one pass-through entity linked to the FT Corporation is accomplished by a process selected from the group consisting of association, cross-ownership and contract.

3. The business structure of claim 1, which further comprises:
at least one Subsidiary FT Corporation controlled by said FT Corporation; and
at least one pass-through entity associated with said at least one Subsidiary FT Corporation.

4. The business structure of claim 1, which further comprises at least one sinking fund controlled by an entity selected from the group consisting of said FT Corporation and said at least one Subsidiary FT Corporation, said at least one sinking fund useable for capitalization and recapitalization purposes.

5. The business structure of claim 1, wherein at least one valuation measure of an investor's equity investment in the equity of a pass-through entity is calculated by the following algorithm:
P_{xy}=CₓA(1−t)+RₓB(1−t)+C_{y}A+R_{y}B

6. The business structure of claim 1, wherein said pass-through entity is a state-charted limited liability company.

7. A method for enabling American Indian Tribes to attract equity capital investment and to provide enhanced returns to non-Tribal investors, said method comprising the steps of:
formation by an American Indian Tribe of a Section 17 Federal Tribal Corporation (FT Corporation);
formation by the Tribe of at least one pass-through entity; and
creating a legal link between said FT Corporation and said pass-through entity establishing investment interests of non-tribal members in said non-tribal entity;
whereby said non-tribal members accrue enhanced rates of return due to the tax-exempt status of the FT Corporation while maintaining a degree of control over their equity investment.

8. The method of claim 7, wherein said linking is accomplished by a process selected the group consisting of association, cross-ownership and contract.

9. The method of claim 7, which further comprises the steps of:
forming at least one Subsidiary FT Corporation controlled by one FT Corporation; and
forming at least one pass-through entity associated with said at least one Subsidiary FT Corporation.

10. The method of claim 7, which further comprises the step of establishing at least sinking fund controlled by an entity selected from the group consisting of said FT Corporation and said at least one Subsidiary FT Corporation, said at least one sinking fund useable for capitalization and recapitalization purposes.

11. The method of claim 7, wherein at least one valuation measure of an investor's equity investment in the equity of a pass-through entity is calculated by the following algorithm:
P_{xy}=CₓA(1−t)+RₓB(1−t)+C_{y}A+R_{y}B

12. The method of claim 7, wherein said pass through entity is a state-charted limited liability company.

13. The method of claim 7, wherein holding, retaining, and recompounding of pass-through earnings from said at least one pass-through entity are optimized for said non-tribal investors, as compared to investor returns of C corporations in a normal federal taxation environment.

14. A business method for deferring federal taxation of corporate profits, said method comprising:
forming a Parent §17 Federal Tribal (FT) Corporation;
forming a Subsidiary §17 Federal Tribal (FT) Corporation, which is controlled by said Parent §17 FT Corporation;
forming at least one pass-through entity, which is linked to the Subsidiary §17 FT Corporation, said pass-through entity having
federal tax exempt status as a disregarded entity; and
equity voting rights and investment basis taxation rights;
wherein said pass-through entity is authorized to sell equity interests therein which are representative of equity capital investments received from non-tribal members; and
whereby said business structure provides an opportunity for said non-tribal investors to receive an enhanced return on investment as a consequence of the tax-exempt status of the FT Corporation, and a degree of control over their equity capital investments.

15. The method of claim 14, wherein linking of said at least one pass-through entity linked to said Subsidiary §17 FT Corporation is accomplished by a process selected from the group consisting of association, cross-ownership and contract.

16. The method of claim 14, wherein said pass through entity is a state-charted limited liability company.

17. The method of claim 14, which further comprises the step of establishing at least sinking fund controlled by an entity selected from the group consisting of said Parent §17 FT Corporation and said Subsidiary §17 FT Corporation, said at least one sinking fund useable for capitalization and recapitalization purposes.

18. The method of claim 14, wherein a computer program using a declarative language is programmed to calculate a valuation of an investor's equity investment in the equity of a pass-through entity using following algorithm:
P_{xy}=CₓA(1−t)+RₓB(1−t)+C_{y}A+R_{y}B

19. The method of claim 14, wherein holding, retaining, and recompounding of pass-through earnings from said at least one pass-through entity are optimized for said non-tribal investors.

20. The method of claim 14, wherein quantitatively larger amounts of qualified dividends associated with issued Preferred Non-voting shares of said pass-through entity can be made to said non-tribal investors than would be possible in a federal taxation environment where C corporations, in which such non-tribal investors owned similar equity interests, are subject to tax on income.
